(19) United States
(12) Patent Application Publication
(10) Pub. No.: US 2025/0388289 A1
(43) Pub. Date: Dec. 25, 2025

(54) CONTROL SYSTEM AND HUMAN-POWERED VEHICLE

(71) Applicant: Shimano Inc., Osaka (JP)

(72) Inventors: Satoshi SHAHANA, Osaka (JP); Toru TAKAYANAGI, Osaka (JP)

(21) Appl. No.: 19/174,454

(22) Filed: Apr. 9, 2025

(30) Foreign Application Priority Data
Jun. 21, 2024 (JP) 2024-100557

(51) Int. Cl. B62M 6/50; B62J 45/411; B62J 45/412; B62J 45/414; B62J 45/415; B62M 9/00; B62M 25/00

(52) U.S. Cl. CPC B62M 6/50; B62J 45/411; B62J 45/412; B62J 45/414; B62J 45/415; B62M 9/00; B62M 25/00

(57) ABSTRACT

A control system includes a controller configured to control an actuator and at least one transmission such that a chain is driven by the actuator and a shifting operation is performed by the at least one transmission. In a case where a pedal is operated during the shifting operation, the controller is configured to control the actuator so that the shifting operation is stopped in accordance with a result of comparison with a predetermined threshold.

### CROSS-REFERENCE TO RELATED APPLICATIONS

This application claims priority to Japanese Patent Application No. 2024-100557, filed on Jun. 21, 2024. The entire disclosure of Japanese Patent Application No. 2024-100557 is hereby incorporated herein by reference.

### BACKGROUND

### Technical Field

The present disclosure generally relates to a control system and a technique of a human-powered vehicle.

### Background Information Art

Control systems for controlling a human-powered vehicle have been known. For example, International Application Publication No WO 2011/158220 A2 (Patent Document 1) discloses a control system that controls a motor configured to apply a propulsion force to a human-powered vehicle so that the motor is stopped immediately before shifting.

### SUMMARY

One object of the present disclosure is to provide a control system capable of contributing to comfortable traveling of a human-powered vehicle, and a human-powered vehicle.

A control system according to a first aspect of the present disclosure is a control system that controls a human-powered vehicle including a pedal, a crank to be mounted with the pedal, a front sprocket rotatable independently of the crank, a rear wheel, a rear sprocket rotatable independently of the rear wheel, a chain meshing with the front sprocket and the rear sprocket, an actuator that drives the chain, and at least one transmission. The control system includes a controller configured to control the actuator and the at least one transmission such that the chain is driven by the actuator and a shifting operation is performed by the at least one transmission. In a case where the pedal is operated during the shifting operation, the controller is configured to control the actuator so that the shifting operation is stopped in accordance with a result of comparison with a predetermined threshold.

According to the control system of the first aspect, the control system can contribute to comfortable traveling of the human-powered vehicle.

In the control system of a second aspect according to the first aspect, the actuator is configured to apply a propulsion force to the human-powered vehicle, the control system includes a at least one detector configured to detect detection information regarding a travel state of the human-powered vehicle, and the controller is configured to control the actuator such that the actuator operates in accordance with a result of comparison between the detection information detected by the at least one detector and at least one predetermined threshold while the shifting operation is stopped.

According to the control system of the second aspect, the chain can be driven by the actuator while the shifting operation is stopped.

In the control system of a third aspect according to the second aspect, the detection information includes at least one of torque information varying in accordance with torque input to the human-powered vehicle, cadence information varying in accordance with a cadence of the human-powered vehicle, crank angle information varying in accordance with an angle of the crank, speed information varying in accordance with a vehicle speed of the human-powered vehicle, inclination information varying in accordance with an inclination angle of the human-powered vehicle, and acceleration information varying in accordance with acceleration of the human-powered vehicle.

According to the control system of the third aspect, the chain can be driven by the actuator while the shifting operation is stopped in accordance with a result of comparison between the threshold and at least one of the torque information, the cadence information, the crank angle information, the speed information, the inclination information, and the acceleration information.

In the control system of a fourth aspect according to the second or the third aspect, the detection information includes at least one of torque information varying in accordance with torque input to the human-powered vehicle and speed information varying in accordance with a vehicle speed of the human-powered vehicle. While the shifting operation is stopped, the controller, in accordance with a result of comparison between the detection information and the threshold, is configured to control the actuator such that the actuator operates when at least one of the speed information being equal to or less than the threshold and the torque information being equal to or greater than the threshold is satisfied, and control the actuator and the at least one transmission such that the shifting operation is resumed in accordance with a result of comparison between the detection information and the threshold when at least one of the speed information being equal to or greater than the threshold and the torque information being less than the threshold is satisfied.

According to the control system of the fourth aspect, the shifting operation can be resumed in accordance with a result of comparison between the detection information and the threshold. This can further contribute to comfortable traveling of the human-powered vehicle.

In the control system of a fifth aspect according to the second or the third aspect, the detection information includes at least one of torque information varying in accordance with torque input to the human-powered vehicle and speed information varying in accordance with a vehicle speed of the human-powered vehicle. While the shifting operation is stopped, the controller, in accordance with a result of comparison between the detection information and the threshold, is configured to control the actuator such that the actuator operates when at least one of the speed information being equal to or less than the threshold and the torque information being equal to or greater than the threshold is satisfied, and control the actuator and the at least one transmission so as to resume the shifting operation when at least one of the speed information being equal to or greater than the threshold and the torque information being less than the threshold is satisfied.

According to the control system of the fifth aspect, the control for operating the actuator and the control for resuming the shifting operation can be switched in accordance with a result of comparison between the detection information and the threshold. This can further contribute to comfortable traveling of the human-powered vehicle.

A human-powered vehicle according to a sixth aspect of the present disclosure comprises the control system according to the first aspect and further comprises a pedal, a crank mounted with the pedal, a front sprocket rotatable independently of the crank, a rear wheel, a rear sprocket rotatable independently of the rear wheel, a chain meshing with the front sprocket and the rear sprocket, an actuator that drives the chain, and at least one transmission.

According to the human-powered vehicle of the sixth aspect, the human-powered vehicle can contribute to comfortable traveling of the human-powered vehicle.

In the human-powered vehicle of a seventh aspect according to the sixth aspect, the actuator is configured to apply a propulsion force to the human-powered vehicle, the human-powered vehicle includes at least one detector configured to detect detection information regarding a travel state of the human-powered vehicle, and the controller is configured to control the actuator such that the actuator operates in accordance with a result of comparison between the detection information detected by the at least one detector and at least one predetermined threshold while the shifting operation is stopped.

According to the human-powered vehicle of the seventh aspect, the chain can be driven by the actuator while the shifting operation is stopped.

In the human-powered vehicle of an eighth aspect according to the seventh aspect, the detection information includes at least one of torque information varying in accordance with torque input to the human-powered vehicle, cadence information varying in accordance with a cadence of the human-powered vehicle, crank angle information varying in accordance with an angle of the crank, speed information varying in accordance with a vehicle speed of the human-powered vehicle, inclination information varying in accordance with an inclination angle of the human-powered vehicle, and acceleration information varying in accordance with acceleration of the human-powered vehicle.

According to the human-powered vehicle of the eighth aspect, the chain can be driven by the actuator while the shifting operation is stopped in accordance with a result of comparison between the threshold and at least one of the torque information, the cadence information, the crank angle information, the speed information, the inclination information, and the acceleration information.

In the human-powered vehicle of a ninth aspect according to the seventh or the eighth aspect, the detection information includes at least speed information varying in accordance with a vehicle speed of the human-powered vehicle and torque information varying in accordance with torque input to the human-powered vehicle. While the shifting operation is stopped, the controller, in accordance with a result of comparison between the detection information and the threshold, is configured to control the actuator such that the actuator operates when at least one of the speed information being equal to or less than the threshold and the torque information being equal to or greater than the threshold is satisfied, and control the actuator and the at least one transmission such that the shifting operation is resumed in accordance with a result of comparison between the detection information and the threshold when at least one of the speed information being equal to or greater than the threshold and the torque information being less than the threshold is satisfied.

According to the human-powered vehicle of the ninth aspect, the shifting operation can be resumed in accordance with a result of comparison between the detection information and the threshold. This can further contribute to comfortable traveling of the human-powered vehicle.

In the human-powered vehicle of a tenth aspect according to the seventh or the eighth aspect, the detection information includes at least speed information varying in accordance with a vehicle speed of the human-powered vehicle and torque information varying in accordance with torque input to the human-powered vehicle. While the shifting operation is stopped, the controller, in accordance with a result of comparison between the detection information and the threshold, is configured to control the actuator such that the actuator operates when at least one of the speed information being equal to or less than the threshold and the torque information being equal to or greater than the threshold is satisfied, and control the actuator and the at least one transmission so as to resume the shifting operation when at least one of the speed information being equal to or greater than the threshold and the torque information being less than the threshold is satisfied.

According to the human-powered vehicle of the tenth aspect, the control for operating the actuator and the control for resuming the shifting operation can be switched in accordance with a result of comparison between the detection information and the threshold. This can further contribute to comfortable traveling of the human-powered vehicle.

### BRIEF DESCRIPTION OF THE DRAWINGS

Referring now to the attached drawings which form a part of this original disclosure, an illustrative embodiment is shown.

FIG. 1 is a side elevational view illustrating a human-powered vehicle (e.g., a bicycle) including a control system according to a first embodiment.

FIG. 2 is a cross-sectional view of a drive unit of the human-powered vehicle illustrated in FIG. 1.

FIG. 3 is a block diagram illustrating an electrical configuration of the human-powered vehicle including the control system.

FIG. 4 is a flowchart illustrating a shifting control process executed by a controller of the control system illustrated in FIG. 3.

FIG. 5 is a flowchart illustrating the shifting control process executed by a controller of the control system illustrated in FIG. 3 according to a first modification.

FIG. 6 is a flowchart illustrating the shifting control process executed by a controller of the control system illustrated in FIG. 3 according to a second modification.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

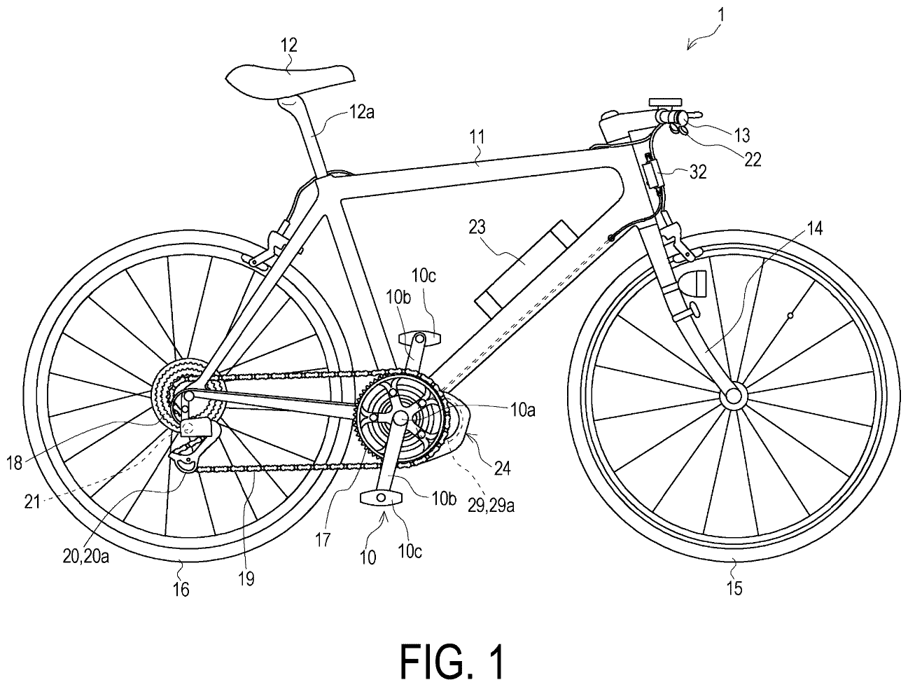

A human-powered vehicle 1 including a control system 33 according to a first embodiment will be described. The human-powered vehicle 1 according to the first embodiment will be described with reference to FIGS. 1 to 4.

The human-powered vehicle 1 is a vehicle that includes at least one wheel and can be driven by at least a human-powered driving force. The human-powered vehicle 1 includes various types of bicycles such as a mountain bicycle, a road bicycle, a city bicycle, a cargo bicycle, a handcycle, and a recumbent bicycle, for example. The number of wheels of the human-powered vehicle 1 is not limited. Examples of the human-powered vehicle 1 include a monocycle and a vehicle including two or more wheels. The human-powered vehicle 1 is not limited to a vehicle that can be driven by only the human-powered driving force. The human-powered vehicle 1 includes an E-bike that uses a driving force of an electric motor in addition to the human-powered driving force for propulsion. The E-bike includes an electrically assisted bicycle, which is assisted in propulsion by the electric motor. Hereinafter, embodiments will be described on the assumption that the human-powered vehicle 1 is an electrically assisted bicycle.

In this description, the following terms “front”, “rear”, “front side”, “rear side”, “left”, “right”, “side”, “upward”, and “downward” meaning directions, and any other similar terms meaning directions, refer to the directions determined with reference to a rider facing a handlebar 13 at a reference position (for example, on a saddle or seat 12) of the human-powered vehicle 1.

The human-powered vehicle 1 includes a pedal 10c, a crank 10 mounted with the pedal 10c, a front sprocket 17 rotatable independently of the crank 10, a rear wheel 16, a rear sprocket 18 rotatable independently of the rear wheel 16, a chain 19 meshing with the front sprocket 17 and the rear sprocket 18, an actuator 29 that drives the chain 19, at least one transmission 20, and the control system 33.

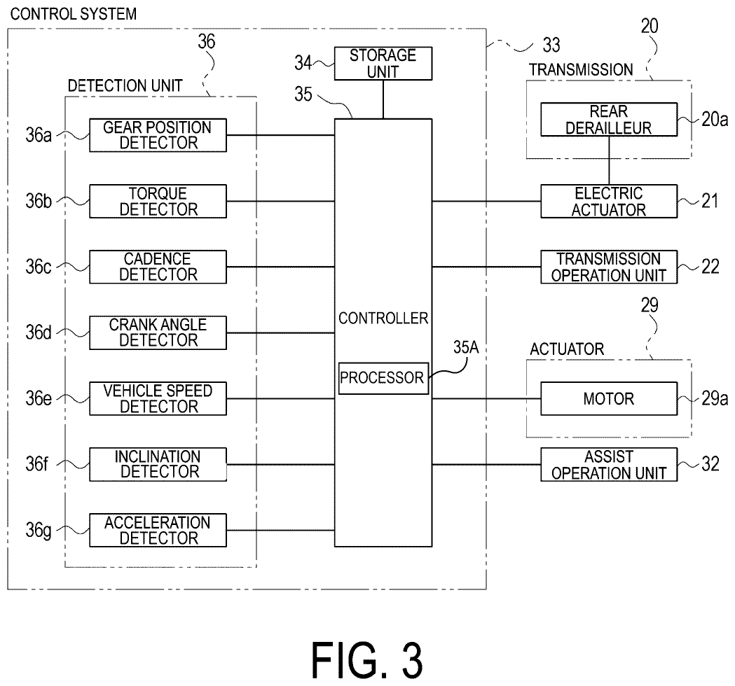

As illustrated in FIGS. 1 and 3, in the present embodiment, the human-powered vehicle 1 includes the crank 10, a frame 11, the seat 12, the handlebar 13, a front fork 14, a front wheel 15, the rear wheel 16, the front sprocket 17, the rear sprocket 18, the chain 19, the transmission 20, an electric actuator 21, a transmission operation unit 22, a battery 23, a drive unit 24, and the control system 33.

The crank 10 includes a crankshaft 10a rotatable relative to the frame 11, and a pair of crank arms 10b respectively provided to either end portion of the crankshaft 10a in an axial direction. The pedal 10c is coupled to each crank arm 10b of the pair of crank arms 10b.

The seat 12 is provided to the frame 11 via a seat post 12a. The frame 11 rotatably supports the handlebar 13 and the front fork 14. The handlebar 13 is configured to be grippable by the rider. The handle bar 13 is rotated relative to the frame 11, causing the front fork 14 to rotate, changing a traveling direction of the human-powered vehicle 1.

The front wheel 15 is rotatably attached to the front fork 14. The rear wheel 16 is rotatably attached to the frame 11. The front sprocket 17 includes one front sprocket 17, for example. The front sprocket 17 can include a plurality of the front sprockets 17. The front sprocket 17 is configured to rotate with the rotation of the crankshaft 10a in the first rotation direction.

The rear sprocket 18 includes a plurality of the rear sprockets 18, for example. The rear sprocket 18 can include one rear sprocket 18. The rear sprocket 18 is coupled to the rear wheel 16 via a one-way clutch. The one-way clutch transmits rotation of the rear sprocket 18 to the rear wheel 16 in a case where the crankshaft 10a rotates in the first rotation direction, causing the front sprocket 17 and, via the chain 19, the rear sprocket 18 to rotate. The human-powered vehicle 1 moves forward by the rotation of the rear sprocket 18 being transmitted to the rear wheel 16. The one-way clutch does not transmit the rotation of the rear sprocket 18 to the rear wheel 16 in a case where the crankshaft 10a rotates in a second rotation direction opposite to the first rotation direction.

The rear sprocket 18 can rotate independently of the rear wheel 16 by being coupled to the rear wheel 16 via the one-way clutch. The rear sprocket 18 can rotate independently of the rear wheel 16, and thus the rotation of the rear sprocket 18 is not transmitted to the rear wheel 16 in a case where a rotational speed of the rear wheel 16 is faster than a rotational speed of the rear sprocket 18.

The transmission 20 includes at least one of an external transmission device and an internal transmission device. In the present embodiment, the transmission 20 includes the external transmission device. In a case where the transmission 20 includes the external transmission device, a gear ratio of the human-powered vehicle 1 is calculated by, for example, dividing the number of teeth of the front sprocket 17 with which the chain 19 is engaged by the number of teeth of the rear sprocket 18 with which the chain 19 is engaged. The external transmission device includes at least one of a front derailleur and a rear derailleur 20a. In the present embodiment, the external transmission device includes the rear derailleur 20a. In a case where the front sprocket 17 includes a plurality of the front sprockets 17, the external transmission device can include a front derailleur.

The electric actuator 21 is configured to operate the rear derailleur 20a. The electric actuator 21 includes, for example, a motor. The electric actuator 21 can further include, for example, a reduction gear coupled to an output shaft of the motor. The electric actuator 21 can be provided to the rear derailleur 20a, or can be provided to a position away from the rear derailleur 20a in the human-powered vehicle 1. The electric actuator 21 is driven to operate the rear derailleur 20a, switching the chain 19 between the plurality of rear sprockets 18. The gear ratio of the human-powered vehicle 1 is changed by switching the chain 19 between the plurality of rear sprockets 18.

The transmission operation unit 22 is configured to be operable by the rider using a hand or a finger. The transmission operation unit 22 is provided to the handle bar 13, for example. The rider operates the transmission operation unit 22, enabling a transmission operation for changing the gear ratio of the human-powered vehicle 1.

The battery 23 includes at least one of a non-rechargeable battery and a rechargeable battery, for example. The rechargeable battery is configured to be rechargeable with power from an external power supply. The battery 23 is provided to the frame 11.

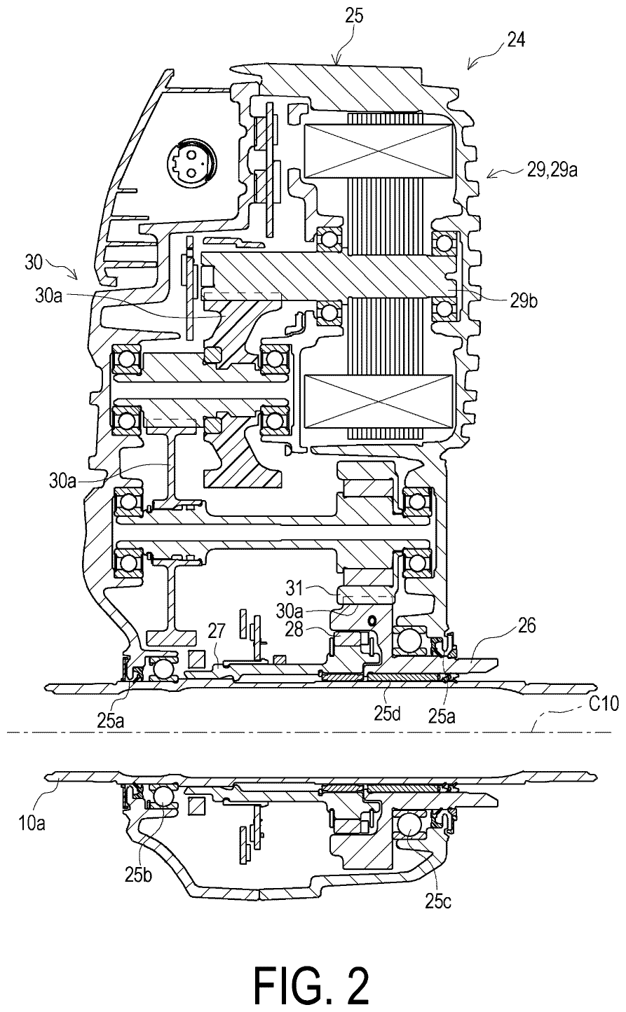

The drive unit 24 is configured to apply a propulsion force to the human-powered vehicle 1 in accordance with the human-powered driving force input to the human-powered vehicle 1. As illustrated in FIG. 2, the drive unit 24 includes a housing 25, an output shaft 26, a transmission shaft 27, a first one-way clutch 28, the actuator 29, a reduction gear 30, and a second one-way clutch 31.

The housing 25 is formed in a hollow shape. The housing 25 includes a pair of through holes 25a penetrating through the housing 25 in the axial direction with respect to a rotational center axis C10 of the crankshaft 10a. The crankshaft 10a is inserted through the pair of through holes 25a. The crankshaft 10a protrudes into an external space of the housing 25 via the pair of through holes 25a.

The output shaft 26 is directly or indirectly coupled to the crankshaft 10a. The output shaft 26 has a substantially cylindrical shape. The output shaft 26 is coaxially disposed with the crankshaft 10a. The output shaft 26 is disposed outward of the crankshaft 10a in a radial direction with respect to the rotational center axis C10 of the crankshaft 10a. Part of the output shaft 26 protrudes into the external space of the housing 25 through one of the pair of through holes 25a. The front sprocket 17 is fixed to the output shaft 26 in the external space of the housing 25. In FIG. 2, the front sprocket 17 is not illustrated.

The crankshaft 10a is rotatably supported by a first bearing 25b relative to the housing 25. The output shaft 26 is rotatably supported by a second bearing 25c relative to the housing 25. The first bearing 25b and the second bearing 25c are disposed in, for example, an internal space of the housing 25. The output shaft 26 rotatably supports the crankshaft 10a via a third bearing 25d. The third bearing 25d is disposed between an outer peripheral surface of the crankshaft 10a and an inner peripheral surface of the output shaft 26.

The transmission shaft 27 and the first one-way clutch 28 are disposed between the crankshaft 10a and the output shaft 26 in a transmission path of the human-powered driving force from the crankshaft 10a to the rear sprocket 18. The transmission shaft 27 is coaxially disposed with the crankshaft 10a. The transmission shaft 27 is fixed to the outer peripheral surface of the crankshaft 10a. Part of the transmission shaft 27 is disposed in an internal space of the output shaft 26. The first one-way clutch 28 is disposed between an outer peripheral surface of the transmission shaft 27 and the inner peripheral surface of the output shaft 26. The first one-way clutch 28 is configured to rotate the front sprocket 17 in a case where the crankshaft 10a rotates in the first rotation direction, and to enable relative rotation between the crankshaft 10a and the front sprocket 17 in a case where the crankshaft 10a rotates in the second rotation direction. The front sprocket 17 can rotate independently of the crank 10 by being coupled to the crankshaft 10a via the first one-way clutch 28.

The actuator 29 is configured to apply a propulsion force to the human-powered vehicle 1. The actuator 29 includes, for example, a motor 29a. The motor 29a is configured to transmit a rotational force to the chain 19 via the output shaft 26, for example. The motor 29a is provided to the housing 25. The motor 29a is disposed in the internal space of the housing 25. The motor 29a includes a motor output shaft 29b.

The reduction gear 30 is configured to couple the motor 29a and the output shaft 26. The reduction gear 30 is provided to the housing 25. The reduction gear 30 is disposed in the internal space of the housing 25. The reduction gear 30 includes, for example, a plurality of outer gears 30a. When the motor output shaft 29b rotates, the plurality of outer gears 30a rotate. With the rotation of the plurality of outer gears 30a, a motor driving force is transmitted to the output shaft 26, and the output shaft 26 rotates. With the rotation of the plurality of outer gears 30a, a rotational speed of the output shaft 26 decreases relative to a rotational speed of the motor output shaft 29b.

The second one-way clutch 31 is provided to the reduction gear 30. The second one-way clutch 31 is configured to transmit the rotation of the motor output shaft 29b to the output shaft 26 and not to transmit the rotation of the output shaft 26 to the motor output shaft 29b.

An assist operation unit 32 illustrated in FIG. 1 is configured to be operable by the rider using a hand or a finger. The assist operation unit 32 includes, for example, at least one assist switch. The rider can perform an assist operation for changing the mode of the drive unit 24 by operating the assist operation unit 32.

The control system 33 illustrated in FIG. 3 is configured to control the human-powered vehicle 1. The control system 33 includes a controller 35. The controller 35 can be referred to as an electronic controller 35. The terms “controller” and “electronic controller” as used herein refer to hardware that executes a software program, and does not include a human being. The controller 35 is formed of one or more semiconductor chips that are mounted on a circuit board. The controller 35 is configured to control the actuator 29 and the at least one transmission 20 such that the actuator 29 drives the chain 19 and the at least one transmission 20 performs a shifting operation. In the present embodiment, the control system 33 further includes a storage unit 34.

The storage unit 34 is configured to store a control program and information used in a control process. The storage unit 34 can also be referred to as memory or a computer storage device. The storage unit 34 is any computer storage device (non-transitory computer-readable medium) but does not include a transitory propagating signal. The storage unit 34 includes, for example, at least one of a non-volatile memory, a volatile memory, and a hard disk. The non-volatile memory includes, for example, at least one of a read-only memory (ROM), an erasable programmable read-only memory (EPROM), an electrically erasable programmable read-only memory (EEPROM), and a flash memory. The volatile memory includes, for example, a random-access memory (RAM).

The controller 35 is configured to execute control regarding the control system 33. The controller 35 includes a processor 35A such as an arithmetic processing device that is configured to execute a control program determined in advance. The processor 35A or arithmetic processing device includes, for example, a central processing unit (CPU) or a micro processing unit (MPU). The CPU or MPU of the controller 35 can be one or more integrated circuits having firmware for causing the circuitry to execute the predetermined control programs and/or complete the activities described herein. The controller 35 can include one or more microcomputers. The controller 35 further includes an inverter circuit connected to the motor 29a.

The controller 35 is configured to communicate with the electric actuator 21, the transmission operation unit 22, the actuator 29, and the assist operation unit 32 through an electric cable or a wireless communication device. By communicating with the electric actuator 21, the controller 35 can control the electric actuator 21 such that the rear derailleur 20a operates.

When the transmission operation unit 22 is operated, a signal regarding the transmission operation is output to the controller 35. The controller 35 controls the electric actuator 21 in accordance with the signal regarding the transmission operation. The controller 35 controls the electric actuator 21 in accordance with the signal regarding the transmission operation, thereby changing the gear ratio of the human-powered vehicle 1 in accordance with the transmission operation by the rider.

The controller 35 communicates with the actuator 29, making it possible to control the actuator 29 such that the motor output shaft 29b rotates. When the motor output shaft 29b rotates, the motor driving force is transmitted to the front sprocket 17 via the reduction gear 30 and the output shaft 26. With the transmission of the motor driving force to the front sprocket 17, the chain 19 is driven.

The drive unit 24 has an assist mode in which a propulsion force is applied to the human-powered vehicle 1 and a non-assist mode in which a propulsion force is not applied to the human-powered vehicle 1. The controller 35 is configured to control the actuator 29 in one of the assist mode and the non-assist mode.

In a case where the actuator 29 is controlled in assist mode, the controller 35 controls the actuator 29 such that a ratio of the motor driving force to the human-powered driving force becomes a predetermined ratio. In this specification, the ratio of the motor driving force to the human-powered driving force is referred to as an assist ratio. In a case where the actuator 29 is controlled in non-assist mode, the controller 35 is configured to control the actuator 29 such that a propulsion force is not applied to the human-powered vehicle 1. The assist mode can include a plurality of assist modes. For example, the assist mode can include a first assist mode, a second assist mode in which a propulsion force higher than that of the first assist mode is readily applied, and a third assist mode in which a propulsion force higher than that of the second assist mode is readily applied.

When the assist operation unit 32 is operated, a signal regarding the assist operation is output to the controller 35. The controller 35 is configured to switch the control of the actuator 29 from one of the assist mode and the non-assist mode to the other of the assist mode and the non-assist mode in accordance with the signal regarding the assist operation. In a case where the assist mode includes a plurality of assist modes, the assist operation unit 32 is configured to enable selection of one mode from the plurality of assist modes and the non-assist mode. In a case where the assist mode includes a plurality of assist modes, the controller 35 is configured to control the actuator 29 in the one mode selected by the rider using the assist operation unit 32.

In the present embodiment, the control system 33 further includes a detection unit 36 that detects detection information regarding a travel state of the human-powered vehicle 1. Here, the control system 33 includes a plurality of detectors 36a to 36g. However, the control system 33 can include at least one detector 36a to 36g configured to detect detection information regarding a travel state of the human-powered vehicle 1. The term “detector” as used herein refers to a hardware device or instrument designed to detect the presence or absence of a particular event, object, substance, or a change in its environment, and to emit a signal in response. The term “detector” as used herein refers to hardware and does not include a human being.

The detection information regarding the travel state is information indicating the state in which the human-powered vehicle 1 is traveling. The detection information includes at least one of torque information varying in accordance with a torque input to the human-powered vehicle 1, cadence information varying in accordance with a cadence of the human-powered vehicle 1, crank angle information varying in accordance with an angle of the crank 10 of the human-powered vehicle 1, speed information varying in accordance with a vehicle speed of the human-powered vehicle 1, inclination information varying in accordance with an inclination angle of the human-powered vehicle 1, and acceleration information varying in accordance with an acceleration of the human-powered vehicle 1. In the present embodiment, the detection information further includes gear position information indicating a current gear position of the at least one transmission 20.

The detection unit 36 is configured to communicate with the controller 35 via an electric cable or a wireless communication device. The detection unit 36 can output a signal corresponding to the detection information to the controller 35. The detection unit 36 includes a gear position detector 36a, a torque detector 36b, a cadence detector 36c, a crank angle detector 36d, a vehicle speed detector 36e, an inclination detector 36f, and an acceleration detector 36g. The gear position detector 36a detects gear position information. In the present embodiment, the gear position detector 36a is configured to detect information indicating a current gear position of the rear derailleur 20a.

The torque detector 36b detects torque information. The torque information includes, for example, at least one of information indicating a torque input to the human-powered vehicle 1, information indicating a power rate, and information indicating work. The power rate and the work are calculated by the torque and the cadence. The torque detector 36b is configured to detect a torque input to the crank arms 10b using, for example, a strain sensor, a magnetostrictive sensor, or a pressure sensor. The strain sensor can include at least one of a metal strain gauge and a semiconductor strain gauge.

In the present embodiment, the cadence detector 36c is provided, and thus the torque detector 36b can use a detection result of the cadence detector 36c in a case where the cadence is detected. The torque detector 36b is configured to detect the power rate and the work on the basis of a detection result of the torque and a detection result of the cadence.

The cadence detector 36c detects cadence information. The cadence information includes, for example, information indicating a cadence that is a number of revolutions per minute of the crank 10. The cadence detector 36c detects the cadence by, for example, detecting a magnet provided to the crankshaft 10a. The cadence detector 36c includes a magnetic detection sensor such as a reed switch or a Hall element.

The crank angle detector 36d detects crank angle information. The crank angle information includes, for example, information indicating a rotation angle of one pedal 10c with a top dead center of the one pedal 10c set to 0°. The crank angle detector 36d includes a magnetic detection sensor that outputs a signal corresponding to a strength of a magnetic field. The crankshaft 10a or a power transmission path from the crankshaft 10a to the front sprocket 17 is provided with an annular magnet having a strength of a magnetic field varying in a circumferential direction. The crank angle detector 36d is configured to detect the rotation angle of one pedal 10c in accordance with the strength of the magnetic field detected by the magnetic detection sensor.

The vehicle speed detector 36e detects vehicle speed information. The vehicle speed information includes, for example, at least one of information indicating the vehicle speed of the human-powered vehicle 1, information indicating a rotational speed of the front wheel 15, and information indicating the rotational speed of the rear wheel 16. The vehicle speed detector 36e includes, for example, a magnetic detection sensor such as a reed switch or a Hall element, for example. The magnetic detection sensor can be attached to a chain stay of the frame 11 and detect a magnet attached to the rear wheel 16. The vehicle speed detector 36e can detect the rotational speed of the rear wheel 16 in accordance with a result of detection of a magnet attached to the rear wheel 16 by the magnetic detection sensor. The magnetic detection sensor can be provided to the front fork 14 and detect a magnet attached to the front wheel 15. The vehicle speed detector 36e can detect the rotational speed of the front wheel 15 in accordance with a result of detection of a magnet attached to the front wheel 15 by the magnetic detection sensor. In the present embodiment, the vehicle speed detector 36e is configured to detect the vehicle speed of the human-powered vehicle 1 on the basis of a result of detection of the rotational speed of one of the front wheel 15 and the rear wheel 16 and a tire circumferential length.

The inclination detector 36f detects inclination information. The inclination information includes, for example, at least one of information indicating an inclination of a travel path of the human-powered vehicle 1 and information indicating a pitch angle of the human-powered vehicle 1. The inclination detector 36f includes, for example, a global positioning system (GPS) reception unit provided to the human-powered vehicle 1. The GPS reception unit is configured to detect a current position of the human-powered vehicle 1. The inclination detector 36f is configured to detect an inclination of a travel path on the basis of a signal output from the GPS reception unit and gradient information included in map information stored in advance in the storage unit 34.

The acceleration detector 36g detects acceleration information. The acceleration information includes, for example, information indicating acceleration in a vertical direction of the human-powered vehicle 1. The acceleration detector 36g includes, for example, an acceleration sensor provided to the human-powered vehicle 1. For example, the inclination detector 36f can detect the pitch angle of the human-powered vehicle 1 on the basis of the acceleration in the vertical direction detected by the acceleration detector 36g.

In the present embodiment, the controller 35 is configured to switch between an automatic shift mode in which the rear derailleur 20a is automatically controlled in accordance with the detection information detected by the detection unit 36 and a manual shift mode in which the rear derailleur 20a is controlled in accordance with the transmission operation by the rider. The human-powered vehicle 1 is provided with a mode operation device for switching from one of the automatic shift mode and the manual shift mode to the other of the automatic shift mode and the manual shift mode.

In order for the rear derailleur 20a to switch the chain 19 between the plurality of rear sprockets 18, the chain 19 needs to be driven. In manual shift mode, the transmission operation is performed according to the intention of the rider. In a case where the transmission operation is performed according to the intention of the rider, the rider basically operates the transmission operation unit 22 while pedaling the pedals 10c. By operating the transmission operation unit 22 while pedaling the pedals 10c, the rider can cause the rear derailleur 20a in manual shift mode to switch the chain 19 between the plurality of rear sprockets 18 to change the gear ratio of the human-powered vehicle 1.

In automatic shift mode, the gear ratio is changed even if the rider does not operate the transmission operation unit 22. In automatic shift mode, in a case where, for example, the vehicle speed suddenly decreases, the electric actuator 21 operates the rear derailleur 20a such that the gear ratio decreases. For example, in a case where the vehicle speed of the human-powered vehicle 1 suddenly decreases while traveling uphill, the electric actuator 21 operates the rear derailleur 20a such that the gear ratio decreases.

In automatic shift mode, in a case where, for example, the vehicle speed of the human-powered vehicle 1 rapidly increases, the electric actuator 21 operates the rear derailleur 20a such that the gear ratio of the human-powered vehicle 1 rises. For example, in a case where the rider pedals the pedals 10c while traveling on a flat road, causing the vehicle speed of the human-powered vehicle 1 to suddenly rise, the electric actuator 21 operates the rear derailleur 20a such that the gear ratio rises. The rider can easily cause the human-powered vehicle 1 to travel at a constant cadence by the gear ratio being adjusted by the operation of the rear derailleur 20a.

In automatic shift mode, the rear derailleur 20a is operated regardless of the intention of the rider. In a case where the rear derailleur 20a is operated regardless of the intention of the rider, the pedals 10c may not be pedaled. For example, in a case where the human-powered vehicle 1 travels downhill and in a case of deceleration, the pedals 10c may not be pedaled to such an extent that the chain 19 is switchable between the plurality of rear sprockets 18, even though the gear ratio of the human-powered vehicle 1 is desirably changed. The controller 35, in a case where the pedals 10c are not pedaled, can drive the chain 19 by the motor 29a of the actuator 29 and operate the rear derailleur 20a. In the present specification, the shifting operation of the rear derailleur 20a in a state where the pedals 10c are not pedaled and the chain 19 is driven by the motor 29a is referred to as a motor-driven shifting operation.

By execution of the motor-driven shifting operation, the rear derailleur 20a can change the gear ratio of the human-powered vehicle 1 by switching the chain 19 between the plurality of rear sprockets 18 in a case where the pedals 10c are not pedaled. Whether the motor-driven shifting operation is executed can be selected in advance by the rider. In a case where the rider enables execution of the motor-driven shifting operation in advance, the motor-driven shifting operation is executed in both manual shift mode and automatic shift mode. The motor-driven shifting operation is executed by the controller 35 controlling the electric actuator 21 and the actuator 29.

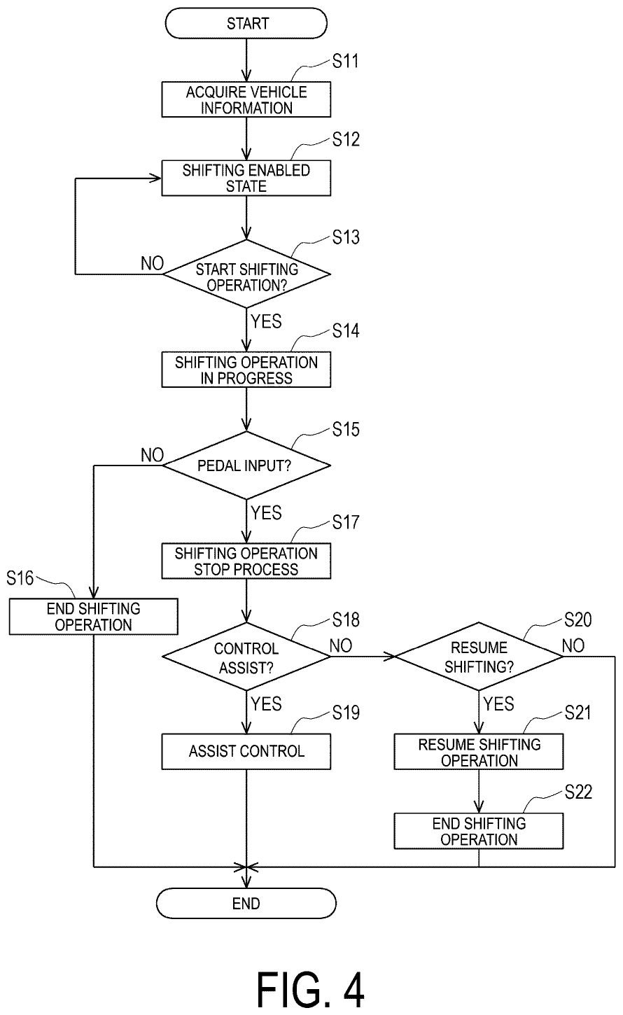

The controller 35 is configured to execute a shifting control process for executing the motor-driven shifting operation. In the shifting control process, in a case where the pedals 10c are operated during the shifting operation, the controller 35 controls the actuator 29 so that the shifting operation is stopped in accordance with a result of comparison with a predetermined threshold. An example of the shifting control process will now be described with reference to FIG. 4. The controller 35 starts the shifting control process in a case where a predetermined condition is satisfied. In the present embodiment, the controller 35 starts the shifting control process in a case where the human-powered vehicle 1 is powered on. When the shifting control process ends, the controller 35 repeatedly executes the shifting control process at a predetermined time interval. In the present embodiment, the controller 35 repeatedly executes the shifting control process until the human-powered vehicle 1 is powered off.

In step S11, the controller 35 acquires vehicle information. In the present embodiment, the controller 35 acquires the detection information detected by the detection unit 36. The controller 35 acquires, for example, the current gear position of the rear derailleur 20a, the torque, the power rate, the work, and the cadence input to the human-powered vehicle 1, the rotation angle of one pedal 10c, the vehicle speed of the human-powered vehicle 1, the inclination of the travel path, and the acceleration in the vertical direction. The controller 35 can acquire, among the current gear position, the torque, the power rate, the work, the cadence, the rotation angle, the vehicle speed, the inclination, and the acceleration, only the portion of information necessary for the processes after step S12. After performing the process of step S11, the controller 35 proceeds to step S12.

In step S12, the controller 35 proceeds to step S13 in a case of an enabled state obtained by the rider enabling execution of the motor-driven shifting operation in advance. In step S13, in a case where a shifting execution condition for starting the motor-driven shifting operation is satisfied, the controller 35 proceeds to step S14. In a case where the shifting execution condition is not satisfied, the controller 35 proceeds to step S12.

The shifting execution condition is satisfied in a case where the current gear position is not appropriate, in a state in which the pedals 10c are not pedaled during travel of the human-powered vehicle 1, and in a state in which a propulsion force is not applied to the human-powered vehicle 1 by the actuator 29. The state in which the pedals 10c are not pedaled during travel of the human-powered vehicle 1 is, for example, a state in which the vehicle speed acquired by the controller 35 in step S11 is equal to or greater than 3 kilometers per hour and the cadence acquired by the controller 35 in step S11 is less than 5 rpm. The state in which a propulsion force is not applied to the human-powered vehicle 1 by the actuator 29 is, for example, a state in which the torque acquired by the controller 35 in step S11 is less than a predetermined threshold.

In the present embodiment, a case where the current gear position is not appropriate means that the cadence required to achieve the current vehicle speed at the current gear position is a value at which the rider is unlikely to pedal comfortably. In a case where the pedals 10c are not pedaled during travel of the human-powered vehicle 1, the cadence acquired by the controller 35 in step S11 does not match the required cadence. With the cadence acquired in step S11 not matching the required cadence, the controller 35 estimates the required cadence. In the present specification, the required cadence estimated by the controller 35 is described as an estimated cadence.

The estimated cadence is calculated in accordance with the vehicle speed and the cadence acquired by the controller 35 in step S11. The estimated cadence is calculated by, for example, the equation (1) below.

C=S*1000*RN/FN/T/60 (1)

The term C in equation (1) is the estimated cadence. The term S in equation (1) is the vehicle speed acquired by the controller 35 in step S11. The unit of S in equation (1) is per hour. The term RN in equation (1) is a number of teeth of the rear sprocket 18 corresponding to the current gear position acquired by the controller 35 in step S11. The number of teeth of the rear sprocket 18 corresponding to the current gear position is the number of teeth of the rear sprocket 18 with which the chain 19 is engaged. The term FN in equation (1) is a number of teeth of the front sprocket 17. The term T in equation (1) is the tire circumferential length of the human-powered vehicle 1. The unit of T in equation (1) is meters.

The controller 35, in a case where the estimated cadence is outside the range of the predetermined threshold, determines that the current gear position is not appropriate. In a case where the vehicle speed of the human-powered vehicle 1 suddenly increases or decreases, for example, the estimated cadence is outside the range of the predetermined threshold. The shifting execution condition is satisfied in a case where the vehicle speed acquired by the controller 35 in step S11 is equal to or greater than 3 kilometers per hour, the cadence acquired by the controller 35 in step S11 is less than 5 rpm, and the estimated cadence is outside the range of the predetermined threshold. The controller 35, in a case where the shifting condition is satisfied, proceeds to step S14. The controller 35, in a case where the shifting execution condition is not satisfied, proceeds to step S12.

In step S14, the controller 35 controls the electric actuator 21 and the actuator 29, thereby performing the motor-driven shifting operation. In a case where the estimated cadence calculated by the controller 35 in step S13 is less than a lower limit of the predetermined range, for example, the motor-driven shifting operation is performed such that the gear ratio decreases. In a case where the estimated cadence calculated by the controller 35 in step S13 is greater than the upper limit of the predetermined range, for example, the motor-driven shifting operation is performed such that the gear ratio increases.

In step S14, the controller 35 controls the actuator 29 such that the motor driving force does not exceed a reference value. The reference value is, for example, a motor driving force required to achieve the vehicle speed acquired by the controller 35 in step S11. With the actuator 29 being controlled such that the motor driving force does not exceed the reference value, the actuator 29 can drive the chain 19 to such an extent that a propulsion force is not applied to the human-powered vehicle 1 in a state in which the pedals 10c are not pedaled. With the chain 19 being driven to such an extent that a propulsion force is not applied to the human-powered vehicle 1, the motor 29a can drive the chain 19 such that the rear wheel 16 is not rotationally driven.

In step S15, the controller 35 determines whether the human-powered driving force is input to the pedals 10c during the motor-driven shifting operation. In the present embodiment, the controller 35 determines whether an input condition is satisfied. In a case where the determination is made that the input condition is not satisfied, the controller 35 repeats the process of acquiring the detection information from the detection unit 36 and the process of determining whether the input condition is satisfied.

The input condition is satisfied in a case where the human-powered driving force is detected or in a case where input of the human-powered driving force to the pedals 10c is predicted. The input condition is defined on the basis of the detection information acquired by the controller 35. In the present embodiment, the input condition includes any one of a first input condition to an eighth input condition, or a combination of two or more thereof.

The first input condition is satisfied in a case where the torque value acquired by the controller 35 is equal to or greater than a predetermined threshold. The predetermined threshold can be, for example, 3 Nm. The second input condition is satisfied in a case where the cadence acquired by the controller 35 is equal to or greater than a predetermined threshold. The predetermined threshold can be, for example, 3 rpm. The third input condition is satisfied in a case where the crank angle acquired by the controller 35 is less than a predetermined threshold. The predetermined threshold can be, for example, 30°. The fourth input condition is satisfied in a case where the power rate acquired by the controller 35 is equal to or greater than a predetermined threshold. The predetermined threshold can be, for example, 3 watts.

The fifth input condition is satisfied in a case where the work acquired by the controller 35 is equal to or greater than a predetermined threshold. The predetermined threshold can be, for example, 3 joules. The sixth input condition is satisfied in a case where the vehicle speed acquired by the controller 35 is equal to or greater than a predetermined threshold. The predetermined vehicle speed can be, for example, 3 kilometers per hour. The seventh input condition is satisfied in a case where the inclination of the travel path acquired by the controller 35 is equal to or greater than a predetermined threshold. The predetermined threshold can be, for example, −3%. The eighth input condition is satisfied in a case where the acceleration acquired by the controller 35 is equal to or greater than a predetermined threshold. The predetermined threshold can be, for example, 5 G.

In the present embodiment, the input condition is satisfied in a case where all of the second input condition, the third input condition, and the sixth input condition are satisfied. In a case where the input condition is satisfied before the shifting operation of the rear derailleur 20a ends, the controller 35 proceeds to step S17. In a case where the input condition is not satisfied before the shifting operation of the rear derailleur 20a ends, the controller 35 proceeds to step S16 and controls the actuator 29 such that the driving of the chain 19 is completed after completion of the shifting operation of the rear derailleur 20a. When the driving of the chain 19 ends, the motor-driven shifting operation ends. After performing the process of step S16, the controller 35 ends the shifting control process.

In step S17, the controller 35 controls the electric actuator 21 and the actuator 29 so that the motor-driven shifting operation is stopped, in order to interrupt the shifting operation of the rear derailleur 20a. Under the control of the controller 35, the rear derailleur 20a stops the shifting operation. Under the control of the controller 35, the actuator 29 stops driving the chain 19. After performing the process in step S17, the controller 35 proceeds to step S18.

In the processes after step S18, the controller 35 controls the actuator 29 such that the actuator 29 operates in accordance with a result of comparison between the detection information detected by the detection unit 36 and at least one of the predetermined thresholds while the shifting operation is stopped. In the present embodiment, the controller 35 controls the actuator 29 such that the actuator 29 operates when at least one of the speed information being equal to or less than the threshold and the torque information being equal to or greater than the threshold is satisfied. The control of the actuator 29 includes assist control that applies a propulsion force to the human-powered vehicle 1 in accordance with the human-powered driving force.

In the processes after step S18, when at least one of the speed information being equal to or greater than the predetermined threshold and the torque information being less than the predetermined threshold is satisfied, the controller 35 controls the actuator 29 and the at least one transmission 20 such that the shifting operation is resumed in accordance with a result of comparison between the detection information and the threshold. The processes after step S18 will now be described.

In step S18, the controller 35 determines whether to perform assist control. In the present embodiment, the controller 35 determines that the assist control is to be performed in a case where an assist condition is satisfied. The assist condition is satisfied in a case where a propulsion force can be applied to the human-powered vehicle 1 by the actuator 29 in a state where the rider selects assist mode from among assist mode and non-assist mode. The controller 35 acquires the detection information from the detection unit 36 and determines whether the actuator 29 can apply a propulsion force to the human-powered vehicle 1 in accordance with a first assist condition to a third assist condition.

The first assist condition is satisfied in a case where the vehicle speed acquired by the controller 35 in step S18 is equal to or greater than a predetermined threshold. The predetermined threshold can be set in accordance with, for example, legal regulations. The predetermined threshold can be, for example, 25 kilometers per hour. The predetermined threshold can be, for example, 24 kilometers per hour. The predetermined threshold can be, for example, 45 kilometers per hour.

The second assist condition is satisfied in a case where the torque acquired by the controller 35 in step S18 is equal to or greater than a predetermined threshold. The third assist condition is satisfied in a case where the crankshaft 10a rotates in the first rotation direction. The controller 35 can determine whether the crankshaft 10a rotates in the first rotation direction by, for example, acquiring a history of a detection result of the crank angle from the crank angle detector 36d in step S18.

In the present embodiment, in a case where at least one of the first assist condition and the second assist condition is satisfied, the controller 35 determines that a propulsion force can be applied to the human-powered vehicle 1 by the actuator 29. The controller 35 can determine that a propulsion force can be applied to the human-powered vehicle 1 by a determination different from that in the present embodiment. For example, in a case where all of the first assist condition, the second assist condition, and the third assist condition are satisfied, the controller 35 can determine that a propulsion force can be applied to the human-powered vehicle 1 by the actuator 29. For example, in a case where both the first assist condition and the second assist condition are satisfied, the controller 35 can determine that a propulsion force can be applied to the human-powered vehicle 1 by the actuator 29.

In a case where the rider selects assist mode and the determination is made that a propulsion force can be applied to the human-powered vehicle 1 by the actuator 29, the controller 35 proceeds to step S19. In step S19, the controller 35 performs assist control. When step S19 ends, the controller 35 ends the shifting control process.

In step S18, in a case where the rider selects non-assist mode or in a case where the determination is made that a propulsion force cannot be applied to the human-powered vehicle 1 by the actuator 29, the controller 35 proceeds to step S20. In step S20, the controller 35 determines whether to enable resumption of the motor-driven shifting operation stopped in step S17. For example, the controller 35 acquires the detection information from the detection unit 36, and determines whether to enable resumption of the motor-driven shifting operation by a determination process similar to that of step S13. In a case where the acquired detection information satisfies the shifting execution condition, the controller 35 determines that resumption of the motor-driven shifting operation is to be enabled and proceeds to step S21. In a case where the acquired detection information does not satisfy the shifting execution condition, the controller 35 determines that resumption of the motor-driven shifting operation is not to be enabled and ends the shifting control process.

In step S21, the controller 35 controls the electric actuator 21 and the actuator 29, thereby resuming the motor-driven shifting operation stopped in step S17. By the resumption of the motor-driven shifting operation, the rear derailleur 20a is operated in a state of the chain 19 being driven. When the operation of the rear derailleur 20a ends, the controller 35 proceeds to step S22. In step S22, the controller 35 controls the actuator 29 such that the driving of the chain 19 is ended. After performing the processing in step S22, the controller 35 ends the shifting control process.

The controller 35 executes the shifting control process, stopping the motor-driven shifting operation in a case where the pedals 10c are pedaled during the motor-driven shifting operation. The gear ratio is maintained by the stopping of the motor-driven shifting operation, and thus the controller 35 can contribute to comfortable traveling of the human-powered vehicle 1.

In the present embodiment, in a case where a relatively large torque is input to the human-powered vehicle 1 while the motor-driven shifting operation is stopped, for example, the controller 35 controls the actuator 29 such that a propulsion force is applied to the human-powered vehicle 1. By controlling the actuator 29, the controller 35 can perform the assist control in preference to the control of the shifting operation in a case where a timing of the shifting operation and a timing of application of the propulsion force overlap.

The rider typically pedals to increase the vehicle speed. In a case where the rider pedals, the rider expects that a propulsion force is applied to the human-powered vehicle 1 by the actuator 29. By giving preference to assist control over the control of the shifting operation, the controller 35 can control the actuator 29 such that a propulsion force is applied to the human-powered vehicle 1 in consideration of the intention of the rider during pedaling. The controller 35 can further contribute to comfortable traveling of the human-powered vehicle 1 by performing control in consideration of the intention of the rider.

In the present embodiment, if the shifting execution condition is satisfied in a case where the assist control is not performed in the shifting control process, the motor-driven shifting operation is resumed. With resumption of the motor-driven shifting operation, the rear derailleur 20a can perform the shifting operation before the next shifting control process is executed. With the rear derailleur 20a performing the shifting operation before the next shifting control process is executed, the timing of performing the shifting operation is advanced, making it possible to improve a shifting response.

### Modifications

The description of the present embodiment exemplifies applicable forms of the present invention with no intended limitation. The present invention is applicable to, for example, modifications of the present embodiment, which will be described below, and combinations of at least two modifications that do not contradict each other.

For example, the configuration of the human-powered vehicle 1 and the configuration of the control system 33 in the present embodiment are merely exemplary, and the configurations of the human-powered vehicle 1 and the control system 33 can include various devices not illustrated in the present embodiment, or can have a configuration not including some of the various devices illustrated in the present embodiment.

For example, the human-powered vehicle 1 can include a drive source different from the actuator 29 of the drive unit 24. A drive source different from the actuator 29 can drive the chain 19 in a case where the motor-driven shifting operation is performed.

The various thresholds used in the control exemplified in the present embodiment are not limited, and can be configured as desired. The various thresholds can be changed as desired by way of operation of a predetermined operation device or the like.

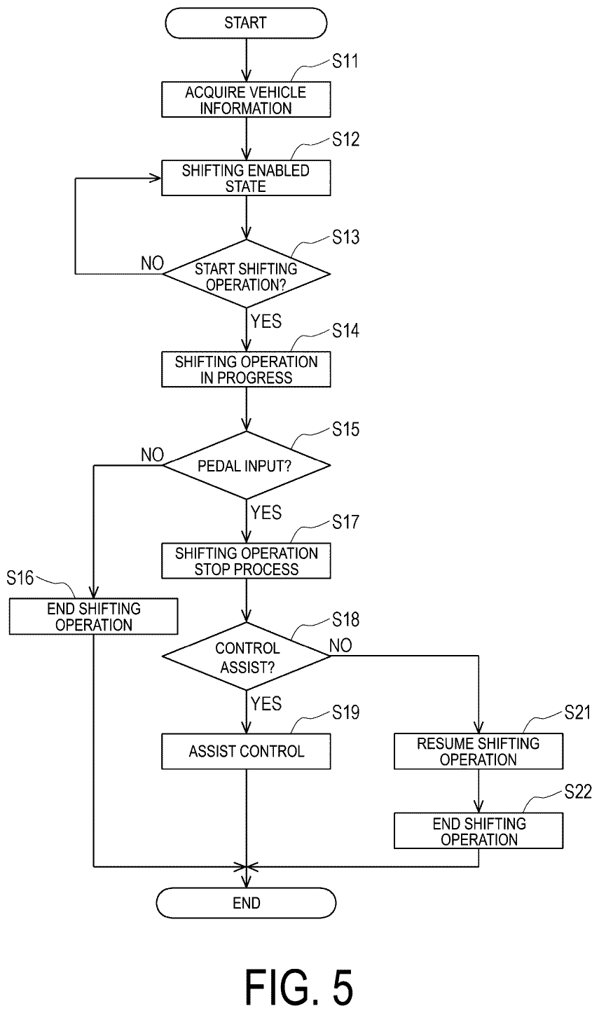

The processing contents and the processing order of the flowcharts illustrated in the present embodiment are examples, and the processing contents and the processing order can be changed as appropriate within the scope of the present invention. For example, the process of step S20 can be omitted as in the shifting control process of a first modification illustrated in FIG. 5.

In step S18 of the shifting control process illustrated in FIG. 5, the controller 35 can acquire, for example, the speed information and the torque information from the detection unit 36. When at least one of the speed information being equal to or greater than the threshold and the torque information being less than the threshold is satisfied, the controller 35 can control the actuator 29 and the at least one transmission 20 such that the shifting operation is resumed.

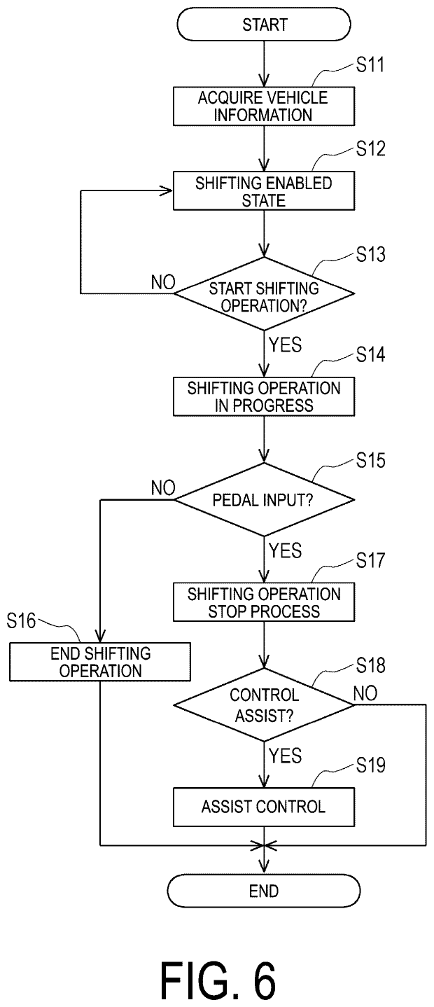

For example, as in the shifting control process of a second modification illustrated in FIG. 6, the processes from step S20 to step S22 can be omitted. In step S18 illustrated in FIG. 6, in a case where the determination is made that the assist control is not to be performed, the controller 35 ends the shifting control process.

The phrase “at least one” as used in this specification means “one or more” of desired options. As one example, in a case where the number of options is two, the phrase “at least one” as used in this description means “only one option” or “both of the two options”. As another example, in a case where the number of options is three or more, the phrase “at least one” as used in this description means “only one option” or “any combination of two or more options”. For instance, the phrase “at least one of A and B” encompasses (1) A alone, (2) B alone, and (3) both A and B. The phrase “at least one of A, B, and C” encompasses (1) A alone, (2) B alone, (3) C alone, (4) both A and B, (5) both B and C, (6) both A and C, and (7) all A, B, and C. In other words, the phrase “at least one of A and B” does not mean “at least one of A and at least one of B” in this disclosure.

What is claimed is:

1. A control system that controls a human-powered vehicle including a pedal, a crank to be mounted with the pedal, a front sprocket rotatable independently of the crank, a rear wheel, a rear sprocket rotatable independently of the rear wheel, a chain meshing with the front sprocket and the rear sprocket, an actuator that drives the chain, and at least one transmission, the control system comprising:
a controller configured to control the actuator and the at least one transmission such that the chain is driven by the actuator and a shifting operation is performed by the at least one transmission,
in a case where the pedal is operated during the shifting operation, the controller being configured to control the actuator so that the shifting operation is stopped in accordance with a result of comparison with a predetermined threshold.

2. The control system according to claim 1, wherein
the actuator is configured to apply a propulsion force to the human-powered vehicle,
the control system includes a at least one detector configured to detect detection information regarding a travel state of the human-powered vehicle, and
the controller is configured to control the actuator such that the actuator operates in accordance with a result of comparison between the detection information detected by the at least one detector and at least one predetermined threshold while the shifting operation is stopped.

3. The control system according to claim 2, wherein
the detection information includes at least one of torque information varying in accordance with torque input to the human-powered vehicle, cadence information varying in accordance with a cadence of the human-powered vehicle, crank angle information varying in accordance with an angle of the crank, speed information varying in accordance with a vehicle speed of the human-powered vehicle, inclination information varying in accordance with an inclination angle of the human-powered vehicle, and acceleration information varying in accordance with acceleration of the human-powered vehicle.

4. The control system according to claim 2, wherein
the detection information includes at least one of torque information varying in accordance with torque input to the human-powered vehicle and speed information varying in accordance with a vehicle speed of the human-powered vehicle, and
while the shifting operation is stopped, the controller, in accordance with a result of comparison between the detection information and the threshold, is configured to
control the actuator such that the actuator operates when at least one of the speed information being equal to or less than the threshold and the torque information being equal to or greater than the threshold is satisfied, and
control the actuator and the at least one transmission such that the shifting operation is resumed in accordance with a result of comparison between the detection information and the threshold when at least one of the speed information being equal to or greater than the threshold and the torque information being less than the threshold is satisfied.

5. The control system according to claim 2, wherein
the detection information includes at least one of torque information varying in accordance with torque input to the human-powered vehicle and speed information varying in accordance with a vehicle speed of the human-powered vehicle, and
while the shifting operation is stopped, the controller, in accordance with a result of comparison between the detection information and the threshold, is configured to
control the actuator such that the actuator operates when at least one of the speed information being equal to or less than the threshold and the torque information being equal to or greater than the threshold is satisfied, and
control the actuator and the at least one transmission so as to resume the shifting operation when at least one of the speed information being equal to or greater than the threshold and the torque information being less than the threshold is satisfied.

6. A human-powered vehicle comprising the control system according to claim 1, and further comprising:
a pedal;
a crank mounted with the pedal;
a front sprocket rotatable independently of the crank;
a rear wheel;
a rear sprocket rotatable independently of the rear wheel;
a chain meshing with the front sprocket and the rear sprocket;
an actuator that drives the chain; and
at least one transmission.

7. The human-powered vehicle according to claim 6, wherein
the actuator is configured to apply a propulsion force to the human-powered vehicle,
the human-powered vehicle includes at least one detector configured to detect detection information regarding a travel state of the human-powered vehicle, and
the controller is configured to control the actuator such that the actuator operates in accordance with a result of comparison between the detection information detected by the at least one detector and at least one predetermined threshold while the shifting operation is stopped.

8. The human-powered vehicle according to claim 7, wherein
the detection information includes at least one of torque information varying in accordance with torque input to the human-powered vehicle, cadence information varying in accordance with a cadence of the human-powered vehicle, crank angle information varying in accordance with an angle of the crank, speed information varying in accordance with a vehicle speed of the human-powered vehicle, inclination information varying in accordance with an inclination angle of the human-powered vehicle, and acceleration information varying in accordance with acceleration of the human-powered vehicle.

9. The human-powered vehicle according to claim 7, wherein
the detection information includes at least speed information varying in accordance with a vehicle speed of the human-powered vehicle and torque information varying in accordance with torque input to the human-powered vehicle, and
while the shifting operation is stopped, the controller, in accordance with a result of comparison between the detection information and the threshold, is configured to
control the actuator such that the actuator operates when at least one of the speed information being equal to or less than the threshold and the torque information being equal to or greater than the threshold is satisfied, and
control the actuator and the at least one transmission such that the shifting operation is resumed in accordance with a result of comparison between the detection information and the threshold when at least one of the speed information being equal to or greater than the threshold and the torque information being less than the threshold is satisfied.

10. The human-powered vehicle according to claim 7, wherein
the detection information includes at least speed information varying in accordance with a vehicle speed of the human-powered vehicle and torque information varying in accordance with torque input to the human-powered vehicle, and
while the shifting operation is stopped, the controller, in accordance with a result of comparison between the detection information and the threshold, is configured to
control the actuator such that the actuator operates when at least one of the speed information being equal to or less than the threshold and the torque information being equal to or greater than the threshold is satisfied, and
control the actuator and the at least one transmission so as to resume the shifting operation when at least one of the speed information being equal to or greater than the threshold and the torque information being less than the threshold is satisfied.
